(19) United States
(12) Patent Application Publication
(10) Pub. No.: US 2023/0185813 A1
(43) Pub. Date: Jun. 15, 2023

(54) SYSTEMS AND METHODS FOR ANALYZING USER INTERACTION DATA USING MACHINE LEARNING TO ORGANIZE SEARCH RESULTS

(71) Applicant: AIRBNB, INC., San Francisco, CA (US)

(72) Inventors: Tao Xu, Palo Alto, CA (US); Surabhi Gupta, San Francisco, CA (US); Brendan Marshall Collins, San Francisco, CA (US)

(73) Assignee: AIRBNB, INC., San Francisco, CA (US)

(21) Appl. No.: 17/658,798

(22) Filed: Apr. 11, 2022

Related U.S. Application Data
(63) Continuation of application No. 16/999,306, filed on Aug. 21, 2020, now abandoned.
Application No. 16/999,306 is a continuation of application No. 15/789,622, filed on Oct. 20, 2017, now abandoned.

(51) Int. Cl. G06F 16/2457; G06F 16/248

(52) U.S. Cl. CPC G06F 16/24578; G06F 16/248

(57) ABSTRACT

A user is associated with initial search requests, and results that comprise attribute types indicative of a common relationship with other results. Each result has an attribute parameter for each attribute type. Search interaction data. Search interaction data comprises attribute parameter data and user interaction data for the search results. A machine learning algorithm is trained to analyze the search interaction data to recognize common relationships, and used to detect a common relationship between the respective attribute parameters for one of the attribute types for which the user interest data indicates interest. When a subsequent search request is received from the user, a user interest characteristic is computed for each result, based on similarity between the attribute preference data detected using the machine learning algorithm and the attribute parameter for the attribute type. The search results are presented to the user, sorted according to user interest characteristic.

### BACKGROUND

Online reservation systems typically provide listings of properties, such as houses, condominiums, rooms, apartments, lots, and other real estate, that a user (referred to hereafter as a “guest”) may reserve for a specified time period (e.g., a day, week, month, or other period of interest). As an example, when a guest is planning a vacation or other type of trip, he or she may use an online reservation system to search property listings in order to find properties of interest for renting during the trip. Such a reservation system often allows the guest to specify various search criteria for use in filtering the results, such as price ranges, dates, number of bedrooms, and other factors that may be of interest to guests in reserving properties, so that the system is more likely to return results of interest to the guest. Providing the guest with more desirable property listings not only enhances the guest's experience with the reservation system, making it more likely that he or she will use the system for future reservations, but also increases the likelihood that the guest will find a property of interest and use the system to make a reservation, sometimes referred to as a “booking.”

However, even with the use of filtering, an online reservation system may return a large number of property listings. Further, the search results may include a relatively large number of listings that satisfy the search criteria of guest's search request yet are not of interest to the guest. Indeed, property listings are inherently unique, and there can be many factors for a guest in selecting a property of interest, including subjective factors that cannot be adequately considered using typical filtering techniques. Thus, a guest often must review many property listings of little or no interest before finding a suitable listing to book. This can increase guest frustration, as well as reduce the likelihood that the search will result in a booking.

A heretofore unaddressed need exists in the art for improving the search results of online reservation system so that guests can more quickly find property listings of interest.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure.

FIG. 1 is a block diagram illustrating a communication system having an online reservation system in accordance with some embodiments of the present disclosure.

FIG. 2 is a block diagram illustrating a web server implementing an online reservation system in accordance with some embodiments of the present disclosure.

FIG. 3 is a block diagram illustrating an online reservation system in accordance with some embodiments of the present disclosure.

FIG. 4 is a block diagram illustrating a displayed list of property listings in accordance with some embodiments of the present disclosure.

FIG. 5 is a flow chart illustrating an exemplary method for processing a search request in accordance with some embodiments of the present disclosure.

### DETAILED DESCRIPTION

The present disclosure generally pertains to online reservation systems for providing improved search results that are more likely to be of interest to guests. In some embodiments of the present disclosure, an online reservation system is configured to receive requests from a guest for searching property listings. For each such search request, the system is configured to return a plurality of property listings that satisfy the search criteria of the request. In addition, the online reservation system also tracks interactions of the guest with the returned property listings in order to determine which of the property listings are of interest to the guest, and the system may determine one or more guest preference parameters indicative of the guest's preferences based on such interactions. As an example, by identifying common attributes among several property listings determined to be of interest to the guest, the system may determine that the guest prefers listings with certain attributes, such as within a certain price range, with certain number of bedrooms, at certain geographic locations (e.g., near a beach, in an urban environment, or in the country), or other attributes deemed to be of interest to the guest. Thereafter, when the guest submits another search request, the system sorts the search results based on the guest preference parameters so that the property listings deemed more likely to be of interest to the guest are ranked higher (e.g., listed first), thereby helping the guest to more quickly find property listings of interest within the search results.

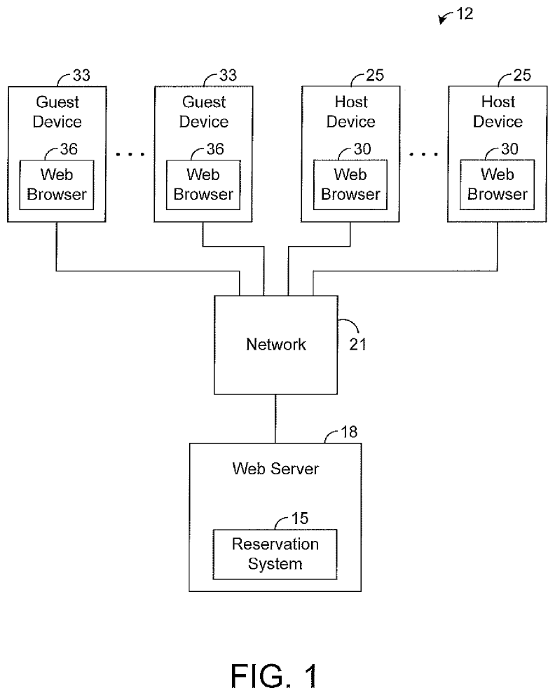

FIG. 1 depicts a communication system 12 having an online reservation system 15 in accordance with some embodiments of the present disclosure. As shown by FIG. 1, the reservation system 15 may be implemented by a web server 18 or other type of device or system that is coupled to a network 18, which may comprise one or more network types, such as a local area network (LAN) or a wide area network (WAN). In some embodiments, the network 21 comprises at least the Internet, but other types of networks or combinations of networks are possible in other embodiments.

As shown by FIG. 1, the communication system 12 may comprise a plurality of host devices 25 that may be used by certain users (referred to herein as “hosts”) to create, modify, or otherwise manage property listings stored at the web server 18. Each host device 25 may be implemented by one or more computing devices, such a desktop computer, laptop computer, or hand-held computer (e.g., a smartphone) for receiving, processing, and outputting information. As shown by FIG. 1, each host device 25 may store a web browser 30 that can be used to communicate with the web server 18 via the network 21 (e.g., the Internet). In this regard, the web server 18 may provide one or more web pages or other web content that is displayed by a host device 25 and used by a host to manage at least one property listing stored and processed by the online reservation system 15, as will be described in more detail hereafter. In other embodiments, the host device 25 may have an application for accessing the reservation system 15 without the use of a web browser 30.

The communication system 12 may also comprise a plurality of guest devices 33 that may be used by guests to request property listing searches, review the results of such searches, and select one or more property listings for bookings. Each guest device 25 may be implemented by one or more computing devices, such a desktop computer, laptop computer, or hand-held computer (e.g., a smartphone) for receiving, processing, and outputting information. As shown by FIG. 1, each guest device 33 may store a web browser 36 that can be used to communicate with the web server 18 via the network 21 (e.g., the Internet). In this regard, the web server 18 may provide one or more web pages or other web content that is displayed by a guest device 33 and used by a guest to search, review, and select property listings stored and processed by the online reservation system 15, as will be described in more detail hereafter. In other embodiments, the guest device 33 may have an application for accessing the reservation system 15 without the use of a web browser 36.

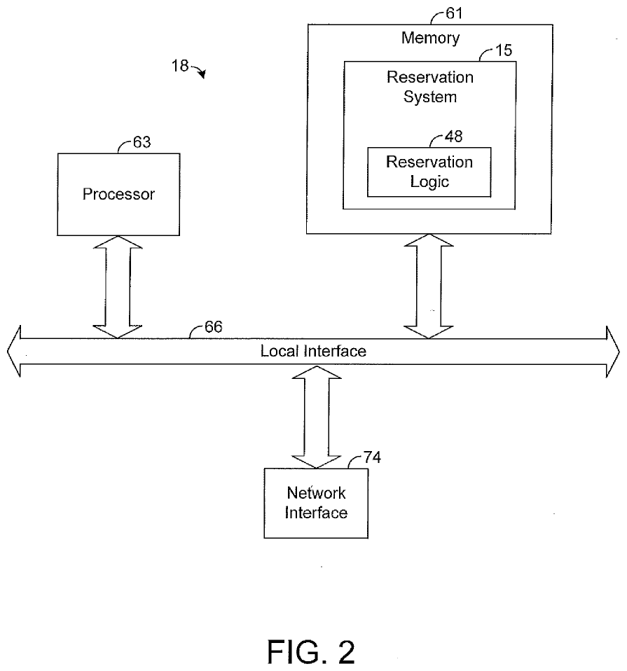

FIG. 2 depicts a web server 18 in accordance with some embodiments of the present disclosure. As shown by FIG. 2, the web server 18 may include a reservation system 15 having reservation logic 48 for performing certain functions, as will be described in more detail hereafter. The reservation logic 48 may be implemented in hardware, software, firmware, or any combination thereof. In the exemplary embodiment illustrated by FIG. 2, the reservation logic 48 is implemented in software and stored in memory 61 of the web server 18.

Note that the reservation logic 48, when implemented in software, can be stored and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The exemplary web server 18 depicted by FIG. 2 comprises at least one conventional processor 63, such as a digital signal processor (DSP) or a central processing unit (CPU), that communicates to and drives the other elements within the web server 18 via a local interface 66, which can include at least one bus. As an example, when the reservation logic 48 is implemented in software, the processor 63 may execute such software as may be desired to implement the functionality of the reservation logic 48 described herein. Furthermore, the web server 18 may have a network interface 74, such as one or more modems, for exchanging data with the network 21 (FIG. 1).

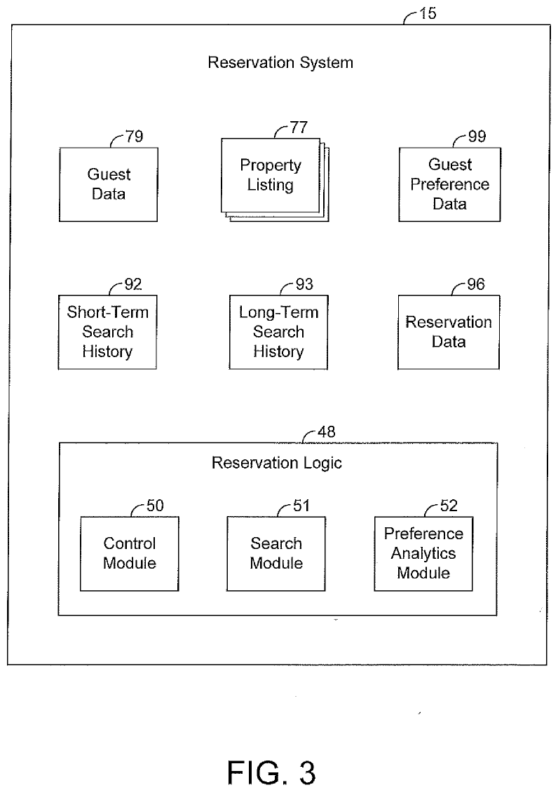

As shown by FIG. 3, the reservation system 15 may include a plurality of property listings 77, which may be stored in the memory 61 (FIG. 1) of the web server 18. As an example, the memory 61 may comprise a database (not specifically shown) in which the property listings 77 can be stored, searched, and manipulated. Each property listing 77 may be associated with a property (e.g., a house, condominium, room, apartment, lot, or other real estate asset) available for renting or leasing by a host. Such a property listing 77 may be defined by uploading information from a host device 25, but other techniques for defining the property listings 77 are possible in other embodiments. Each property listing 77 includes information about the associated property, and such information may be used by guests in deciding whether to book a reservation for the property. As an example, a property listing 77 may include photographs or other images of the property, information describing physical attributes of the property (e.g., number of bedrooms or bathrooms, list of amenities, location, layout, and nearby attractions or activities), information describing rental attributes of the property (e.g., rental price, minimum or maximum length of stay, availability, minimum age for renting, and deposit requirements), or other information that may be of interest to guests in deciding whether to book a reservation for the property.

In some embodiments, as shown by FIG. 3, the reservation logic 48 may include a control module 50, a search module 51, and a preference analytics module 52. As will be described in more detail hereafter, the control module 50 is generally configured to control the operation of the reservation system 15, including responding to and tracking inputs from guests. The search module 51 is configured to search the property listings 77 based on search criteria in search requests received from guests, and the preference analytics module 52 is configured to analyze guest interactions with the displayed web content to identify guest preferences for attributes of the property listings 77, as will be described in more detail hereafter. If desired the various modules 50-52 may run on different processors 63 so as to increase the speed at which the web server 18 is capable of processing data and responding to guest actions. In other embodiments, it is unnecessary for the reservation logic 48 to have multiple modules and/or to run on multiple processors 63.

The reservation system 15 also includes guest data 79, which also may be stored in memory 61 (FIG. 1) of the web server 18. The guest data 79 defines information associated with each guest that has registered with the reservation system 15. As an example, for each such guest, the guest data 79 may include a guest identifier that uniquely identifies the guest relative to other users of the system 15. The guest data 79 may associate such identifier with information about the guest, such as the guest's name, contact information (e.g., mailing address, email address, telephone number, etc.), financial information (e.g., a credit card or debit card number that may be used for making financial payments), information for authenticating the guest (e.g., a username and password) or any other guest information as may be desired. The information for any guest may be acquired during a registration process in which the guest uses a guest device 33 to communicate with the web server 18 and provide the information to be stored in guest data 79. In other embodiments, other techniques for defining the guest data 79 are possible.

When a guest desires to make a reservation for a property, the guest may use a guest device 33 to initiate a communication session with the web server 18 via the network 21. In some cases, the guest may log into the reservation system 15 by providing information for identifying and authenticating him or her so that the system 15 can associate the guest with his or her guest information stored in the guest data 79. In any event, when a communication session is initiated, the control module 50 may be configured to provide one or more web pages or other web content that is transmitted across the network 21 to the guest device 33, which displays the web content to the guest. Such web content may define a graphical user interface (GUI) that permits the guest to provide inputs for various actions, as will be described in more detail hereafter. As an example, the guest device 33 may display a GUI for allowing the guest to submit a search request. Such GUI may include various fields or other graphical elements that allow the guest to input information defining search criteria for the search request. As an example, the guest may specify a desired location for a property to be rented, the type of property desired (e.g., house, condominium, etc.), minimum or maximum number of bedrooms or bathrooms, a price range, dates for renting the property, or any other search criterion typically used to search for property listings.

When the search request is submitted by the guest, the guest device 33 is configured to transmit the search request to the web server 18 via the network 21, and the search module 51 is configured to search the property listings 77 based on the search criteria defined by the search request. In this regard, the search module 51 is configured to filter the property listings 77 based on the search criteria in the received search request to provide a list of property listings 77 that satisfy each criterion of the search request. The control module 50 may be configured to return this list to the guest device 33 so that it can be displayed to the guest that submitted the search request.

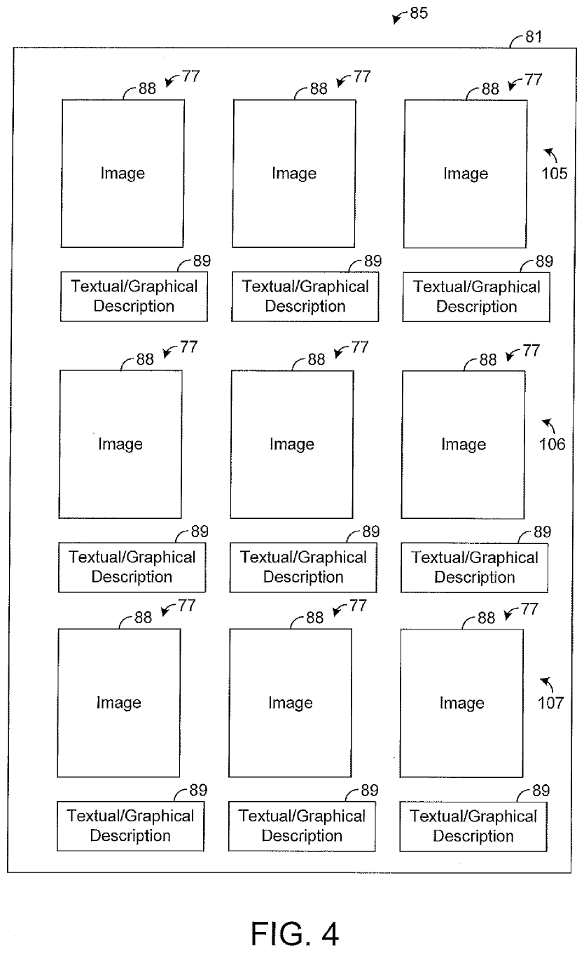

Note that each displayed property listing 77 may include only a subset of overall information of the property listing 77 stored in memory 61. As an example, FIG. 4 shows an exemplary list 85 of property listings 77 that may be returned for a given search request and displayed within a web page 81 or otherwise to the guest. In the example shown by FIG. 4, each property listing 77 in the list 85 has a single image 88 (e.g., a photograph) for the associated property and textual and/or graphical information 89 describing a subset of the attributes for the associated property. As an example, the information 89 may include text or graphical elements specifying or otherwise indicating the daily price for renting the associated property, a brief description of the associated property, the number of beds at the associated property, and the average guest rating provided by guests who have previously stayed at the associated property. In other embodiments, other numbers of images and other types of attributes for the property may be displayed. By limiting the information presented to the guest for each listing 77, the amount of information in the list 85 is generally more manageable for finding potential listings 77 of interest from the list 85. In addition, in the list 85 shown by FIG. 4, the listings 77 are shown as arranged in rows and columns. Specifically, the list 85 has nine displayed listings 77 arranged in three rows and three columns, but any number of listings 77 may be displayed in any number of rows and any number of columns in other embodiments. In addition, other arrangements for the displayed listings 77 are possible in other embodiments.

Upon viewing a list 85 of property listings 77, the guest may provide inputs for manipulating or otherwise processing the property listings 77 in an attempt to find at least one listing 77 for a property that the guest is interested in reserving. As an example, the guest may provide one or more inputs for requesting more information to be displayed to the guest about one or more selected property listings 77. The inputs provided by the guest may be transmitted to the reservation system 15, which processes such inputs to perform the requested actions, which may include displaying more information about the selected property listings 77. The reservation system 15 may also process inputs to track the guest's behavior while he or she is viewing, processing, and analyzing the property listings 77. In some embodiments, the guest inputs are processed by the control module 50, which may include one or more streaming platforms, such as Apache Kafka™, for processing the guest's inputs and tracking the guest's interactions with the displayed property listings 77 over time. Data indicative of such guest interactions may be stored in memory 61.

As an example, when the guest selects a displayed property listing 77 (e.g., clicks on the image 88 or textual/graphical information 89 of the property listing 77), the control module 50 may be configured to display a GUI containing more information about the selected listing 77 so that the guest can make a more informed decision about whether the property associated with the listing 77 is desirable to the guest. As an example, more images, textual information, and/or graphical information describing more attributes for the property associated with the selected listing 77 may be displayed so that the guest may learn more about the associated property relative to the subset of information provided in the list 85 shown by FIG. 4.

As the guest provides inputs for navigating through or otherwise analyzing the displayed information, the control module 50 tracks such inputs in real time and stores data indicative of the guest's interactions with the displayed information. As an example, when the guest selects a property listing 77 from the list 85 in order to view more information about the listing 77, the control module 50 may store information indicating the occurrence of the selection in data 92, referred to hereafter as “short-term search history.” Thus, the short-term search history 92 may be analyzed to determine which of the property listings 77 have been selected by the guest over time, including the number of times that each of property listings 77 is selected during a given time period. The control module 50 may also store other information in the short-term search history 92, such as the amount of time that the guest spends viewing one or more portions of the more detailed information of the property listing 77, whether and possibly when or how many times the guest submits a request for more information from the host associated with the property listing 77, whether the guest booked a reservation for the property listing 77, and/or any other information that may indicate whether the guest is interested in the property listing 77.

Notably, the control module 50 may track the guest's interactions over time, including across multiple communication sessions and search requests. In this regard, each time the guest logs into the reservation system 15, his or her interactions may be tracked and correlated with previous interactions so that the interactions from multiple sessions are linked to or otherwise associated with the same guest in the short-term search history data 92. In some embodiments, the short-term search history data 92 is indicative of the guest's interactions over some recent time period, such as the last two weeks, and the tracked guest interactions greater than such time period are separately stored in memory 61 as long-term search history 93. In other embodiments, it is unnecessary for data indicative of more recent guest interactions to be separated from data indicative of other guest interactions.

The control module 50 may be configured to maintain data 96, referred to herein as “reservation data,” indicative of the reservations made by guests. When the guest finds a property listing 77 of interest for making a reservation, the guest may provide one or more inputs for booking a reservation for the property associated with the listing 77. In response, the control module 50 may be configured to update the reservation data 96 to indicate the reservation. As an example, the reservation data 96 may be updated to indicate the name and address of the guest, the property listing 77 associated with the reservation, the dates for the reservation, and any other information that may be desired. In other embodiments, other techniques for tracking reservations are possible.

The preference analytics module 52 may be configured to analyze the short-term search data 92 and/or the long-term search data 93 to identify guest preferences for property attributes. In this regard, by analyzing the guest interactions with the property listings 77 indicated by the short-term search data 92 and/or long-term search data 93, the preference analytics module 52 may identify at least one attribute that is sufficiently common among a plurality of property listings 77 such that it is likely that the guest has a preference for such attribute. In such case, the preference analytics module 52 may define and store in guest preference data 99 associated with the guest a parameter, referred to herein as “guest preference parameter,” indicative of such attribute for which the guest is deemed to have a preference. Notably, unlike filtering parameters, the guest performance parameter is not specified by the guest but rather is determined by the preference analytics module 52 by analyzing guest interactions with the property listings 77. The guest preference parameters may then be used to sort the results of other searches requested by the same guest, as will be described in more detail below.

As an example, assume that a guest submits a search request that requires property listings 77 to be within a price range of less than $1000 per day. In response, the search module 51 may return a list 85 of a relatively large number of property listings 77 associated with prices less than $1000 per day. Based on the guest interactions with the search results, the preference analytics module 52 may determine that a large number of property listings 77 deemed to be of interest to the guest are within a relatively narrow price range, such as between about $600 to $800 per day even though the filtering performed by the search module 51 was for a much broader range. In such an example, the preference analytics module 52 may determine that the guest has a preference for property listings within the range of $600 to $800 per day and store a guest preference parameter indicative of this identified pricing attribute. Thereafter, when the guest submits another search request, the control module 50 may be configured to sort the search results based on this guest preference parameter.

As an example, property listings 77 correlated with the attribute indicated by the guest preference parameter (i.e., property listings 77 associated with a price within the $600 to $800 per day in the current example) may be positioned in the list 85 above or otherwise in front of property listings 77 that are not correlated with such attribute (i.e., property listings 77 associated with a price in a range outside of $600 to $800 per day). Thus, the first property listings 77 viewed by the guest in a list 85 are likely to be ones correlated with the identified attribute and thus more likely to be of interest to the guest.

Note that, in the above example, only the results of a single search are used to identify a preferred attribute and to define a guest preference parameter. However, as will be illustrated below, guest interactions with the results of a multitude of searches may be used to identify an attribute that is preferred by the guest and/or to define a guest preference parameter for such attribute. In addition, it should also be noted that price is just one example of an attribute that may be identified as a guest preference, and there are various other types of attributes that may be identified as guest preferences in other examples. The search module 51 may use any number of guest preference parameters as factors in determining how to sort the search results so that property listings 77 more likely to be of interest to the guest are positioned in a list 85 to increase the probability that they will be viewed earlier by the guest.

It should be further noted that there can be many techniques used by the preference analytics module 52 to determine when the guest is interested in a given property listing 77. As an example, the preference analytics module 52 may determine that the guest is interested in a particular property listing 77 when he or she selects it for viewing more information about the listing 77 or, alternatively, selects it at least a predefined number of times for viewing more information. In another embodiment, the preference analytics module 52 may determine that the guest is interested in a property listing 77 when he or she is determined to view the property listing 77 for at least a predefined amount of time. In yet another embodiment, the guest may specify when he or she is interested in a particular listing 77. As an example, the GUI displayed to the guest may have a graphical element (e.g., an icon) associated with the displayed property listing 77 that is selected by the guest to indicate that he or she is interested in the associated property listing 77. In other embodiments, other techniques may be used to determine which property listings 77 are of interest to the guest, and it is possible to use any combination of techniques. Indeed, any of the techniques described above for determining whether a property listing 77 is of interest to a guest may be a factor in an algorithm to assess the guest's overall interest in the property listing 77. For example, the preference analytics module 52 may determine that at guest is interested in a particular listing 77 when the guest has both selected the listing a predetermined number of times and has also viewed the listing for at least a predetermined amount of time.

In some embodiments, the preference analytics module 52 may calculate a value, referred to hereafter as “interest score,” for each property listing 77 indicative of the likely interest level of the guest in the respective property listing 77. Such score may be updated as the guest performs actions indicative of interest in the property listing 77. As an example, the interest score may be increased the longer the guest views or interacts with the listing 77. The interest score may also be increased by a certain amount each time the guest selects the listing 77 for viewing more information about the listing 77. In some embodiments, the guest may be permitted to specify or otherwise control the interest score. As an example, the guest may be permitted to enter or otherwise define a value indicating the guest's interest level in a property listing 77. In such an example, a higher value entered by the guest may indicate a greater interest, but other techniques for specifying or otherwise indicating the interest score are possible.

The preference analytics module 52 may be configured to compare the interest score to a predetermined threshold and determine that the guest is interested in the corresponding property listing 77 if the interest score is within a certain range of the threshold (e.g., exceeds the threshold). Yet other techniques for determining whether the guest is interested in a given property listing 77 are possible in other embodiments.

As described above, the preference analytics module 52 may be configured to analyze the guest interactions (as indicated by the short-term search history 92 and/or long-term search history 93) with the property listings 77 deemed to be of interest to the guest in order to determine guest preferences. There are many types of guest preferences that may be identified. As an example, as described above, the preference analytics module 52 may determine a preferred price range for the guest. Other types of preferences include a range for guest ratings, a type of accommodation (e.g., bed & breakfast, condominium, house, etc.), a property location (e.g., near a beach, in the country, in an urban environment, etc.), a range for a number of bedrooms or bathrooms, whether smoking or pets are allowed, whether the property listing includes a certain amenity (e.g., a hot tub, a pool, a fireplace, a game room, etc.), or any other property attribute that is sufficiently common among the property listings of interest to likely indicate a preference for such attribute. For example, in some embodiments, if the preference analytics module 52 determines that a number or percentage of the property listings 77 of interest above a predetermined threshold include a certain property attribute (e.g., price within a certain range, number of bedrooms within a certain distance, located within a certain distance range of a beach or urban environment, etc.), then the preference analytics module 52 may identify such attribute as a preference and store a guest preference parameter indicative of the attribute. In other embodiments, other techniques for identifying preferences and determining guest preference parameters are possible.

In some embodiments, the preference analytics module 52 may use a machine learning algorithm to analyze the guest interactions with the property listings 77 deemed to be of interest and determine guest preference parameters based on such interactions. As known in the art, machine learning algorithms generally involve training a computer through the use of artificial intelligence by analyzing sample data sets to recognize data patterns that likely result in certain outputs or outcomes. Such machine learning algorithms may be used by the preference analytics module 52 to learn guest interactions indicative of certain guest preferences in order to define the guest preference parameters. Yet other techniques for identifying guest preferences based on guest interactions with the property listings 77 and determining the guest preference parameters are possible in other embodiments.

Note that the algorithm used to identify a given guest preference may involve the use of several factors that are weighted differently as may be desired. As an example, in deciding whether the guest has a preference for a certain attribute (e.g., a certain price range or range for a number of bedrooms), the preference analytics module 52 may analyze guest interactions indicated by the both the short-term search history 92 and the long-term search history 93. However, the guest interactions in the short-term search history 92 may be given greater weight in the preference identification algorithm such that they have a greater effect on whether a certain attribute is identified as a guest preference relative to the guest interactions in the long-term search history 93. Such a weighted algorithm may be based on the assumption that, in general, more recent guest interactions with the property listings 77 are likely better indicators of the guest's current preferences relative to older interactions. In other embodiments, other techniques for weighting the guest interactions differently are possible.

In addition, it is also possible for guest preferences to be categorized such that different categories of guest preferences are used for different types of searches. As an example, the preference analytics module 52 may be configured to categorize preferences based on location or property type. In this regard, guests may have different preferences for properties of a different type or at a different location. For example, a guest may prefer properties that are higher-priced when they are located on or near a beach. In such an example, the preference analytics module 52 may determine (e.g., learn) that the guest's price preference is different for property listings 77 associated with a location on or near a beach relative to the guest's price preference for other locations. Based on such information, the module 52 may define a first guest preference parameter indicative of a first price range, referred to hereafter as “beach price range,” based on guest interactions with property listings 77, referred to hereafter as “beach property listings,” for properties that are (1) deemed to be of interest to the guest and (2) located on or near a beach. The module 52 may also define a second guest preference parameter indicative of a second price range, referred to hereafter as “non-beach price range,” based on guest interactions with property listings 77, referred to hereafter as “non-beach property listings,” for properties that are (1) deemed to be of interest to the guest and (2) not located on or near a beach. The first guest preference parameter may be categorized for use with beach property listings 77, and the second guest preference parameter may be categorized for use with non-beach property listings 77. In such case, after the search module 51 has performed one or more searches, the control module 50 may compare beach property listings 77 to the first guest preference parameter indicative of the beach price range to determine the guest's likely interest level in such beach property listings 77. The control module 50 may also compare non-beach property listings 77 to the second guest preference parameter indicative of the non-beach price range to determine the guest's likely interest level in such non-beach property listings 77.

In other embodiments, other types of preference categories are possible. As an example, guest interactions with the property listings 77 may indicate that the guest prefers a different price range when searching for properties (1) in a particular city (e.g., a city having a higher cost of living index), (2) in a certain area of a city, (3) in a certain country (e.g., a country having a higher currency exchange rate), (4) having certain amenities (e.g., a hot tub or pool), (5) in an urban environment, (6) in a non-urban environment, (7) having a certain type of accommodations (e.g., a house), or (8) having a number of bedrooms or bathrooms above a threshold. Each property listing 77 may include information indicative of whether the associated property matches any such factors, and the preference analytics module 52 may use such information to determine the appropriate category of guest preference parameter to be compared to the property listing 77. For example, a property listing 77 may indicate that the associated property is located in an urban environment, and the preference analytics module 52 may use such information to select a guest preference parameter categorized for urban properties (e.g., indicative of the guest's preferred price range for properties located in urban environments) for comparison to the property listing 77.

Notably, similar techniques for categorizing preferences may be used for types of property attributes other than price. As an example, guest interactions with the property listings 77 may indicate that the guest prefers properties having a hot tub or fireplace when searching for properties within a certain location (e.g., in the mountains). In another example, the preference analytics module 52 may determine that the guest prefers a certain accommodation type (e.g., a house or cabin) when searching for properties in non-urban environments but prefers another type of accommodation (e.g., a condominium) when searching in urban environments or other geographic locations. The same techniques described above for price may be used for these other types of property attributes.

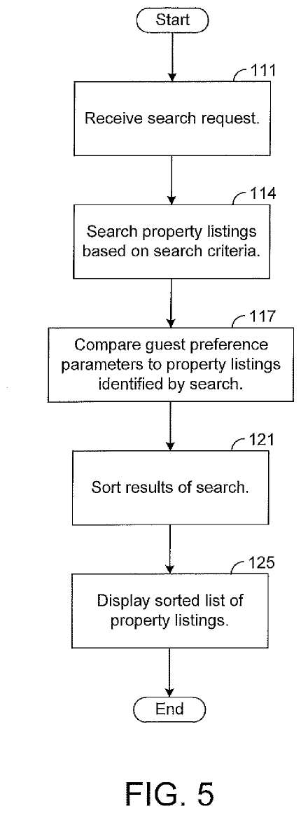

After one or more guest preference parameters for a given guest are defined, the control module 50 may use the guest preference parameters to sort the search results from the search module 51. In this regard, when the reservation system 15 receives a search request from a guest device 33, the search module 51 searches the property listings 77 for listings, referred to as “hits,” that satisfy the search criteria of the search request from the guest that submitted the request, as shown by blocks 111 and 114 of FIG. 5. The preference analytics module 52 also compares the guest preference parameters for the guest to the property listings 77 satisfying the search criteria, as shown by block 117 of FIG. 5, in order to rank such property listings according to how well the property listings match the guest's preferred attributes indicated by the guest preference parameters. As an example, for each property listing 77, the preference analytics module 52 may define a value, referred to hereafter as “preference score,” indicating the extent to which the property listing 77 is deemed to match the guest's preferred attributes. In some embodiments, a higher value for the preference score indicates that the property listing 77 better matches the guest's preferred attributes, but other types of preference scores are possible in other embodiments.

There are various techniques that can be used to calculate or otherwise determine a preference score for a property listing 77. In some embodiments, the preference analytics module 52 increases the preference score for each property attribute (as indicated by the property listing 77) that matches a guest preference parameter defined for the guest that submitted the search request. As an example, assume that one of the guest preference parameters indicates a price range, as described above. In such an example, the preference analytics module 52 may be configured to compare the price indicated by a property listing 77 to the guest preference parameter to determine whether the property's price is within the range indicated by the guest preference parameter. If so, the search module 51 may increase the listing's preference score by a predefined amount. The preference score may be similarly increased when other guest preference parameters match their corresponding property attributes indicated by the listing 77. Thus, a higher preference score generally indicates that more guest preference parameters match their corresponding property attributes and the guest, therefore, likely has a greater preference for the listing 77. In other embodiments, the preference scores may be defined differently (e.g., such that a smaller value indicates a greater preference for a listing 77). If desired, the guest preference parameters may be weighted in the algorithm used to calculate the preference score so that one guest preference parameter, when deemed to match its corresponding property attribute, has a greater effect on the preference score than another.

After calculating the preference scores for the property listings 77 satisfying the search criteria of the search request, the preference analytics module 52 may be configured to sort the listings 77 based on their preference scores, and the control module 50 may then send the sorted list 85 to the guest device 33 for display to the guest, as shown by blocks 121 and 125 of FIG. 5. As an example, the property listings 77 may be sorted in descending order such that the listings 77 having the highest preference scores are at the top of a list 85 displayed to the guest. In such an example, each of the property listings 77 appearing in the top row 105 may have a higher preference score than each of the property listings 77 in the next row 106 that is below the top row 105. Further, each of the property listings 77 appearing in the row 106 may have a higher preference score than each of the property listings 77 in the next row 107, and so on. Thus, in such an example, property listings 77 having higher preference scores should appear higher in the list 85 so that they are viewed by the guest before property listings 77 having lower preference scores. Further, as indicated above, a higher preference score for a property listing 77 generally indicates that the listing 77 better matches the guest preferences identified by the preference analytics module 52. Thus, by sorting the property listings, as described above, it is more likely that the guest will more quickly find a property listing 77 that the guest is interested in booking.

As described above, the guest analytics module 52 may utilize machine learning to implement various functionality described herein. In some embodiments, the guest analytics module 52 comprises a deep learning neural network for sorting the property listings 77 based on guest preferences. In this regard, the deep learning neural network may be trained based on the guest interactions indicated by the short-term search history 92 and/or the long-term search history 93 to learn the preferences of the guest, indicated by an embedded vector within the deep learning neural network, and then sort the property listings 77 such that they are listed in order according to the extent to which the listings 77 match the guest's preferences, as described above. That is, the property listings 77 may be sorted such that the listings 77 most likely preferred by the guest are listed before the other listings 77.

As indicated above, a guest's preferred price range may vary depending on various factors, and the preference analytics module 52 may take into account different factors when deciding which price range is preferred for a given listing 77. In some embodiments, the guest's location may be used as a factor for selecting a preferred price range to be compared to a property listing 77 in block 117 of FIG. 5. In this regard, there may be trends in preferred price ranges that can be learned from guest location and such preferred price trends may be used to select or otherwise define the preferred price range for a given guest.

As an example, it may be determined that guests from a particular country tend to prefer properties within a certain price range (e.g., higher priced properties or lower priced properties) relative to guests from other countries. Such information may be determined by analyzing and comparing the short-term search histories 92, long-term search histories 93, and/or guest preference parameters of multiple guests from multiple countries. This information may also be determined with other techniques, such as surveys. In the instant example, for a given search request, the preference analytics module 52 may determine a guest preference parameter for price based on the country associated with the guest that submitted the search request.

In other embodiments, other types of locations may be used to determine a preferred price range for a guest. As an example, it may be determined that guests in a certain city or state are likely to prefer properties in a certain price range different than guests in other cities or states. It is also possible that guests in different regions of the same city or state prefer different price ranges or that guests in different region types prefer different price ranges. As an example, it may be determined that guests in urban environments prefer a different price range relative to guests in non-urban environments. A certain preferred price range can be correlated with any type of guest region as may be desired. Further, it should also be noted that other types of property attributes may be based on the location of the guest. As an example, it may be determined that guests from a particular region (e.g., country or city) prefer a certain amenity or guest rating range. Similar techniques may be used to determine a guest's preference for any type of property attribute based on a location of the guest.

Note that there are various techniques that that the preference analytics module 52 may use to determine the location (e.g., country) of the guest. In some embodiments, the module 52 may retrieve the location information from the guest data 79 that is associated with the guest. In this regard, when the guest logs into the reservation system 15, the guest may provide an identifier (e.g., username) that identifies the guest, and the module 52 may use this identifier to find the guest data 79 pertaining to the identified guest and to retrieve the guest's location information from such data 79. If desired, other techniques may be used to determine the location (e.g., country) associated with the guest. As an example, it is possible to find a location of a guest device 33 using an Internet protocol (IP) address received from the guest device 33, or the guest could be prompted to enter location information that is transmitted to the reservation system 15. Yet other techniques may be used in other embodiments.

Note that the guest's location may be used as a factor for determining a preferred price range at any time, including before the preference analytics module 52 has learned a desired price range based on the guest interactions indicated by the short-term search history 92 and/or the long-term search history 93. As the module 52 learns the guest's preferences over time, the guest's preferred price range may be weighted differently (e.g., weighted less on the guest's location and more on the behavior indicated by the guest interactions). As an example, when a guest first begins to use the reservation system 10, the guest's preferred price range may be initially based on the guest's location. As the guest uses the system 15 and interacts with the results over time, the preference analytics module 52 may learn that the guest prefers a slightly different price range than the one initially selected based on the guest's location. Over time, the guest preference parameter, referred to hereafter as the “preferred price parameter,” indicative of the guest's preferred price range may be weighted more heavily on the guest interactions so that the effect of the guest's location on the preferred price range is decreased.

In addition, the preferred price parameter for a guest may be based on many other factors in addition to or in lieu of guest location. As an example, it may be determined that a guest may have a different preferred price range depending on the number of people for the reservation or the number of bedrooms or beds for which the guest is searching. In this regard, when defining the search criteria for a search request, the guest may indicate the number of people to stay at the property being reserved or the minimum number of bedrooms or beds that the guest is seeking. The minimum number of bedrooms or beds is generally based on the number of people intended to stay at the property. In this regard, a larger number of bedrooms or beds generally implies that a larger number of people will be staying at the property. The guest interactions may reveal that the guest prefers properties having a higher price when searching for properties for accommodating a greater number of people or having a larger number of bedrooms or beds. Thus, the preference analytics module 52 may be configured to select or otherwise determine the guest's preferred price parameter for use in block 117 of FIG. 5 based on search criteria, such as a minimum number of bedrooms or beds for a reservation or a number of people expected to stay for a reservation.

As an example, the preference analytics module 52 may define one preferred price parameter indicative of a first price range to be used for a search request that specifies a number of people or bedrooms in a first range, and the preference analytics module 52 may define another preferred price parameter indicative of a second price range to be used for a search request that specifies a number of people or bedrooms in a second range. When a search request is received, the preference analytics module 52 retrieves the guest's preferred price parameter corresponding with the number of people or bedroom range indicated by the search criteria of the search request and uses such preferred price parameter to compare to the property listings 77 in block 117 of FIG. 5. Thus, the guest's preference for price to be used in sorting the search results of a given search request is based at least partially on the request's search criteria, such as the number of people or bedrooms specified in the search request.

When a guest is located in a different country relative to the location of the listed property, currency fluctuations may affect the guest's preferred price range. In this regard, when the currency for the country in which the listed property is located (referred to hereafter as “listing's country”) strengthens relative to the currency of the country in which the guest is located (referred to hereafter as “guest's country”), then the currency fluctuation makes the property more expensive to the guest. In such a situation the preferred price range for the guest may be lower due to the change in the currency exchange rate. Conversely, when the currency for the listing's country weakens relative to the currency of the guest's country, then the currency fluctuation makes the property less expensive to the guest. In such a situation the preferred price range for the guest may be higher due to the change in the currency exchange rate. In some embodiments, the preference analytics module 52 takes currency fluctuations into account when selecting or otherwise determining the guest's preferred price parameter for use in comparing the property listings 77 that satisfy a search request in block 117 of FIG. 5.

There are several techniques that can be used to determine a guest's preferred price parameter based on currency fluctuations. In some embodiments, the preference analytics module 52 may be configured to correlate a guest's preferred price parameter with a value, referred to herein as “baseline currency value,” indicative of a baseline currency exchange rate (e.g., an average currency exchange rate between the currency for the listing's country and the currency for the guest's country during a time period, such as during the time period of the guest interactions used to define the guest's preferred price parameter). When a property listing 77 is identified by the search module 51 as satisfying a received search request, the preference analytics module 52 may compare the baseline currency value to the current exchange rate between the currency for the listing's country and the currency for the guest's country. If the difference is greater than a threshold, then the preference analytics module 52 may adjust the guest's preferred price parameter to account for the difference. As an example, if the current exchange rate is less than the baseline currency value indicating that the currency for the guest's country has weakened relative to the currency for the listing's country, then the preference analytics module 52 may reduce the price range indicated by the guest's preferred price parameter. However, if the current exchange rate is greater than the baseline currency value indicating that the currency for the guest's country has strengthened relative to the currency for the listing's country, then the preference analytics module 52 may increase the price range indicated by the guest's preferred price parameter. If desired, the amount of change to the price range indicated by the guest's preferred price parameter may be based on (e.g., be proportional to) the difference between the current currency exchange rate and the baseline currency value. In other embodiments, other techniques for selecting or otherwise determining the preferred price range to be compared to the price of the property listing are possible.

In some embodiments, the preference analytics module 52 may be configured to learn a preferred location category for the listed properties and to define at least one guest preference parameter based on such information. As an example, by analyzing the guest interactions indicated by the short-term search history 92 and/or long-term search history 93, the preference analytics module 52 may determine that the guest prefers at least one location category for properties, such as in the mountains, in rural areas, in urban environments, near beaches, near amusement parks, near national parks, or other categories of geographic areas or points of interest. In such case, the module 52 may define a guest preference parameter, referred to hereafter as “property category parameter,” indicative of the preferred location category and use such property category parameter to sort the property listings 77 to be displayed to the guest in response to a search request, according to the techniques described above. As an example, when the location category for a property listing 77 matches a preferred location category indicated by the guest's property category parameter, the module 52 may increase the interest value associated with the listing 77 indicating that the listing 77 is more likely to be of interest to the guest, thereby causing the listing 77 to be positioned higher in the list 85 by the sorting described above. In other embodiments, other techniques for using the property category parameter in sorting the property listings 77 are possible.

Note that there are various techniques that can be used to identify a location category for a listed property. In some embodiments, each property listing 77 includes location category information that can be accessed and used by the preference analytics module 52 to identify the property's location category. As an example, a property listing 77 may include information indicating whether the listed property is within one or more particular location categories, such as any of the exemplary categories indicated above (e.g., in the mountains, in rural areas, in urban environments, near beaches, near amusement parks, near national parks, or other geographic areas or points of interest). In other embodiments, the property listing 77 may simply indicate the location of the listed property (e.g., a set of geographic coordinates), and the preference analytics module 52 may compare the property's location to a map to determine a location category for the property. Such a map may indicate different predefined location categories for different areas. In yet other embodiments, other techniques may be used to identify a location category for a listed property.

By knowing the location categories for the property listings 77, the preference analytics module 52 can analyze the location categories for the property listings 77 deemed to be of interest to the guest in order to identify trends in the location categories. As an example, the preference analytics module 52 may determine that a guest has a preference for a particular location category when the number or percentage of property listings 77 of interest associated with such category exceeds a certain threshold. Other techniques for identifying one or more preferred location categories for a guest are possible in other embodiments.

In some embodiments, a preferred location category may be a specific geographic sub-region of a region indicated by the search criteria of a search request. As an example, it may be determined by the preference analytics module 52 or otherwise that when the guest searches for properties within a certain region defined by the search criteria, such as a specific city, the guest prefers listings 77 for properties within a certain sub-region, such as within a certain neighborhood of the city or within a certain distance of a geographic point of interest (e.g., a beach or amusement park). In such an example, the preference analytics module 52 may define a guest preference parameter that indicates the geographic sub-region. Thereafter, if the location of a property for a property listing 77 satisfying a search request is within the identified sub-region, the preference analytics module 52 may determine that the property is within a preferred location category. Thus, the module 52 may increase the interest value associated with the listing 77 indicating that the listing 77 is more likely to be of interest to the guest, thereby causing the listing 77 to be positioned higher in the list 85 by the sorting described above.

It should be noted that any guest preference parameter may be determined using any combination of the techniques described herein. As an example, it is possible for the preference analytics module 52 to determine an initial price range for a guest preference parameter based on a location of the guest, as described above. The preference analytics module 52 may adjust the price range based on other factors such preferences indicated by guest interactions with the property listings 77, search criteria, a currency exchange rate, and/or a location category for a property listing 77 to be compared to the guest preference parameter, as indicated above.

The foregoing is merely illustrative of the principles of this disclosure and various modifications may be made by those skilled in the art without departing from the scope of this disclosure. The above described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

What is claimed is:

1. A method of sorting search results of a search performed by a user, comprising the steps of:
during an initial phase:
receiving a plurality of initial search requests submitted by the user;
identifying the user and associating the user with the plurality of initial search requests;
for each initial search request, providing a plurality of search results displayable on a search results user interface in response to the respective initial search requests, wherein each of the plurality of search results comprises a plurality of attribute types indicative of a common relationship between the respective search result and other search results of the plurality of search results, each of the plurality of search results having an attribute parameter for each of the plurality of attribute types;
collecting search interaction data indicative of interactions by the user with at least some of the plurality of search results via the search results user interface, wherein the search interaction data comprises:
attribute parameter data relating to the attribute parameters for each of the attribute types of each of the search results with which the user has interacted, and
user interaction data indicating user interest with respect to interaction with the search result by the user;
training a machine learning algorithm to analyze the search interaction data to recognize common relationships in data patterns;
detecting, using the machine learning algorithm to analyze the search interaction data, a common relationship between the respective attribute parameters for one of the plurality of attribute types of the search results for which the user interest data indicates interest of the user,
upon detection of the common relationship for the respective attribute parameters for one of the plurality of attribute types, storing:
attribute preference data relating to the attribute type, and
the respective attribute parameter data, for which the commonality was detected;
during an implementation phase:
receiving a subsequent search request after the plurality of initial search requests, from the user;
identifying a plurality of subsequent search results;
for each of the plurality of subsequent search results, computing a user interest characteristic based on a degree of similarity between the attribute preference data detected using the machine learning algorithm and the attribute parameter for the attribute type of the subsequent search results;
sorting the identified plurality of subsequent search results into an order based on the user interest characteristic for each of the plurality of subsequent search results; and
transmitting to the user an ordered list of subsequent search results, sorted based on the user interest characteristic.

2. The method of claim 1, wherein the user interaction data indicating interest of the user with respect to the interaction of the user with the search result comprises data relating to
(i) a number of times the user has interacted with the search result, and
(ii) a duration of time the user has spent viewing and interacting with the search result.

3. The method of claim 2, wherein the user interaction data indicating interest of the user with respect to the interaction of the user with the search result comprises data relating to
(iii) a number of requests the user has submitted for additional information regarding the search result, and
(iv) a number of transactions the user has initiated with respect to the search result.

4. The method of claim 1, wherein the subsequent search request comprises a user-specified sorting parameter, and wherein the step of transmitting to the user an ordered list of subsequent search results, sorted by user interest value further comprises transmitting to the user an ordered list of subsequent search results, sorted first by the user-specified sorting parameter and second by the user interest characteristic.
